(19) United States
(12) Patent Application Publication
(10) Pub. No.: US 2026/0213267 A1
(43) Pub. Date: Jul. 23, 2026

(54) SECONDARY BATTERY AND ELECTRIC APPARATUS

(71) Applicant: CONTEMPORARY AMPEREX TECHNOLOGY CO., LIMITED, Ningde (CN)

(72) Inventors: Jie Guo, Ningde (CN); Changlong Han, Ningde (CN); Guan Wang, Ningde (CN)

(21) Appl. No.: 19/568,845

(22) Filed: Mar. 17, 2026

Related U.S. Application Data
(63) Continuation of application No. PCT/CN2025/073058, filed on Jan. 17, 2025.

(30) Foreign Application Priority Data
Nov. 17, 2023 (CN) 202311534864.7

(51) Int. Cl. H01M 10/0567; H01M 4/02; H01M 4/131; H01M 4/505; H01M 4/525; H01M 10/0525

(52) U.S. Cl. CPC H01M 10/0567; H01M 4/131; H01M 4/505; H01M 4/525; H01M 10/0525; H01M 2004/021; H01M 2004/028

(57) ABSTRACT

A secondary battery and an electric apparatus are provided. The secondary battery includes a positive electrode plate, a negative electrode plate, and an electrolyte disposed between the positive electrode plate and the negative electrode plate. The electrolyte includes LiFSI with a mass percentage of a. The positive electrode plate includes a positive electrode active material having a Dv99 particle size of y1 μm, where y1 ranges from 5 to 15. The secondary battery satisfies the relationship 100≤y1/a≤10000. By controlling the relationship between the particle size Dv99 of the positive electrode active material and the LiFSI content in the electrolyte, the secondary battery exhibits improved temperature rise performance during fast charging while maintaining battery service life.

### RELATED APPLICATIONS

The present application is a continuation of International Application PCT/CN2025/073058, filed on Jan. 17, 2025, which claims priority to the Chinese Patent Application No. 2023115348647, filed with the China National Intellectual Property Administration on Nov. 17, 2023 and entitled “SECONDARY BATTERY AND ELECTRIC APPARATUS”, which is incorporated herein by reference in its entirety.

### TECHNICAL FIELD

The present application relates to the field of new energy technologies, and in particular, to a secondary battery and an electric apparatus.

### BACKGROUND

In recent years, with increasingly wide use of secondary batteries such as lithium-ion batteries, for example, lithium-ion batteries have been widely used in energy storage power supply systems such as hydroelectric, thermal, wind, and solar power plants, as well as many other fields including electric tools, electric bicycles, electric motorcycles, electric vehicles, military equipment, and aerospace. Along with the great development of lithium-ion batteries, higher requirements are imposed, especially on their fast charging performance and on solving the thermal runaway problem resulting from an excessive temperature rise during the fast charging process.

### SUMMARY

The present application provides a secondary battery and an electric apparatus capable of improving fast charging performance and addressing the thermal runaway problem resulting from an excessive temperature rise during the fast charging process.

To achieve the above purpose, according to a first aspect, the present application provides a secondary battery including a positive electrode plate, a negative electrode plate, and an electrolyte disposed between the positive electrode plate and the negative electrode plate, where
the electrolyte includes LiFSI with a mass percentage of a, the positive electrode plate contains a positive electrode active material, Dᵥ99 of the positive electrode active material is y₁ μm, y₁ ranging from 5 to 15, and the secondary battery satisfies the following condition: 100≤y₁/a≤10000.

Without wishing to be bound by any theory, in the above secondary battery of the present application, the addition of LiFSI to the electrolyte can reduce the temperature rise. However, excessive LiFSI, due to its own poor oxidation resistance, may adversely affect the service life of the battery. The use of a positive electrode active material with a relatively small Dᵥ99 value can reduce the temperature rise. However, an excessively small Dᵥ99 may reduce the service life of the battery. The present application achieves improved temperature rise performance during the fast charging process by controlling the relationship between Dᵥ99 and the LiFSI content, while mitigating the service life problems associated with LiFSI and Dᵥ99.

In some implementations of the present application, the secondary battery satisfies at least one of the following conditions:

y₁ ranges from 5 to 12; (1)

0<a≤10%; and (2)

200≤y₁/a≤5000. (3)

In some implementations of the present application, y₁ ranges from 5 to 10.

In some implementations of the present application, 0.01%≤a≤10%.

In some implementations of the present application, 0.1%≤a≤5%.

In some implementations of the present application, the secondary battery satisfies at least one of the following conditions:

$$1 \% \leq a \leq 5 \% ; and \qquad ( 1 )$$

$$200 \leq {y}_{1} / a \leq 600 . \qquad ( 2 )$$

In some implementations of the present application, 2%≤a≤4%.

In some implementations of the present application, Dᵥ50 of the positive electrode active material is y₂ μm, and the secondary battery satisfies the following condition: 1.2≤y₁/y₂≤7.

The control of a ratio of Dᵥ99 to Dᵥ50 of the positive electrode active material enables the secondary battery to achieve an optimal balance of excellent fast charging performance, cycle life, and hot box safety performance, while having a lower temperature rise.

In some implementations of the present application, the secondary battery satisfies at least one of the following conditions:

y₂ ranges from 1.5 to 6; and (1)

2≤y₁/y2≤6. (2)

In some implementations of the present application, y₂ ranges from 2 to 5. Optionally, y₂ ranges from 3 to 5.

When y₂ is in the ranges of 1.5 to 6, 2 to 5, or 3 to 5, and y₁/y₂ is in the range of 2 to 6, the battery has longer cycle life and hot box safety performance.

In some implementations of the present application, the positive electrode active material includes a nickel-cobalt-manganese ternary positive electrode material.

In some implementations of the present application, in a total molar mass of nickel element, cobalt element, and manganese element in the nickel-cobalt-manganese ternary positive electrode material, a molar proportion of the cobalt element is 5% to 15%, and a molar proportion of the nickel element is 50% to 90%.

In some implementations of the present application, in the total molar mass of nickel element, cobalt element, and manganese element in the nickel-cobalt-manganese ternary positive electrode material, the molar proportion of the cobalt element is 9% to 15%, and the molar proportion of the nickel element is 50% to 70%.

The control of the molar proportion of the nickel element and the molar proportion of the cobalt element within this range enables the battery to have longer cycle life and hot box safety performance.

In some implementations of the present application, the compaction density of the negative electrode plate is less than or equal to 1.6 g/cm³.

In some implementations of the present application, the secondary battery further includes a separator disposed between the positive electrode plate and the negative electrode plate, and a Gurley value of the separator is 100s to 600s.

In some implementations of the present application, the Gurley value of the separator is 400s to 500s.

According to a second aspect, the present application further provides an electric apparatus including the secondary battery according to the first aspect of the present application.

The electric apparatus of the present application includes the secondary battery provided by the present application, and thus has at least the same advantages as the secondary battery.

Details of one or more embodiments of the present application are provided in the following accompanying drawings and description. Other features, purposes, and advantages of the present application become apparent from the specification, the accompanying drawings, and the claims.

### BRIEF DESCRIPTION OF DRAWINGS

Reference may be made to one or more of the accompanying drawings for the purpose of better describing and illustrating those embodiments or examples provided in the present application. The additional details or examples used to describe the accompanying drawings should not be considered as limitations on the scope of any one of the present application disclosed herein, the currently described embodiments or examples, and the best mode of the present application as currently understood. In addition, in all the accompanying drawings, the same reference signs represent the same components. In the drawings:

FIG. 1 is a schematic diagram of a battery cell according to an implementation of the present application.

FIG. 2 is an exploded view of the battery cell shown in FIG. 1 according to an implementation of the present application.

FIG. 3 is a schematic diagram of a battery module according to an implementation of the present application.

FIG. 4 is a schematic diagram of a battery pack according to an implementation of the present application.

FIG. 5 is an exploded view of the battery pack shown in FIG. 4 according to an implementation of the present application.

FIG. 6 is a schematic diagram of an electric apparatus using the secondary battery as a power source according to an implementation of the present application.

Reference signs are described as follows:

1 battery pack; 2 upper box body; 3 lower box body; 4 battery module; 5 battery cell; 51 housing; 52 electrode assembly; 53 cover plate; and 6 electric apparatus.

### DESCRIPTION OF EMBODIMENTS

The following discloses some implementations of a secondary battery and an electric apparatus of the present application with appropriate reference to detailed descriptions of the accompanying drawings. However, there may be cases in which unnecessary detailed descriptions are omitted. For example, detailed description of a well-known matter or repeated description of an actually identical structure has been omitted. This is to avoid unnecessarily prolonging the following descriptions, for ease of understanding by persons skilled in the art. In addition, the accompanying drawings and the following descriptions are provided for persons skilled in the art to fully understand the present application and are not intended to limit the subject described in the claims.

“Ranges” disclosed in the present application are defined in the form of lower and upper limits. A given range is defined by one lower limit and one upper limit selected, where the selected lower and upper limits define boundaries of that special range. Ranges defined in this way may or may not include end values, and any combination may be used, meaning that any lower limit may be combined with any upper limit to form a range. For example, if ranges of 60-120 and 80-110 are provided for a specific parameter, it should be understood that ranges of 60-110 and 80-120 can also be envisioned. In addition, if minimum limit values of a range are given as 1 and 2, and maximum limit values of the range are given as 3, 4, and 5, the following ranges can all be envisioned: 1-3, 1-4, 1-5, 2-3, 2-4, and 2-5. In the present application, unless otherwise specified, a value range of “a-b” is a short representation of any combination of real numbers between a and b, where both a and b are real numbers. For example, a value range of “0-5” means that all real numbers from “0-5” are listed herein, and “0-5” is just an abbreviated representation of a combination of these values. In addition, a parameter expressed as an integer greater than or equal to 2 is equivalent to listing that the parameter is, for example, an integer among 2, 3, 4, 5, 6, 7, 8, 9, 10, 11, 12, and so on. For example, a parameter expressed as an integer selected from “2-10” is equivalent to listing integers of 2, 3, 4, 5, 6, 7, 8, 9, and 10.

In the present application, the terms such as “a plurality of” and “multiple,” unless specifically specified, refer to a quantity greater than or equal to 2. For example, “one or more” means one or more than or equal to two.

Unless otherwise stated, all the implementations and optional implementations of the present application can be combined with each other to form new technical solutions.

In this specification, reference to “embodiment” means that specific features, structures, or characteristics described with reference to the embodiment may be included in at least one embodiment or implementation of the present application. The word “embodiment” appearing in various places in the specification does not necessarily refer to the same embodiment or an independent or alternative embodiment that is exclusive of other embodiments. It is explicitly or implicitly understood by persons skilled in the art the embodiments described herein may be combined with other embodiments. The term “implementation” in the present description has a similar understanding.

It can be understood by persons skilled in the art that in the foregoing method in the various embodiments and implementations, the writing order of the steps does not imply a strict order of execution or constitute any limitation on the process of implementation, and a specific execution order of the steps should be determined based on their functions and possible internal logics. Unless otherwise stated, all the steps in the present application can be performed in the order described or in random order, preferably, in the order described. For example, a method including steps (a) and (b) indicates that the method may include steps (a) and (b) performed sequentially or may include steps (b) and (a) performed sequentially. For example, the foregoing method may further include step (c), indicating that step (c) may be added to the method in any ordinal position, for example, the method may include steps (a), (b), and (c), steps (a), (c), and (b), steps (c), (a), and (b), or the like.

In the present application, open technical features or technical solutions described with words such as “contain”, “include”, and “comprise”, unless otherwise specified, do not exclude additional members other than those listed, and can be regarded as providing both closed features or solutions consisting of the listed members and open features or solutions that include additional members other than the listed members. For example, A includes a1, a2, and a3, unless otherwise specified, may also include other members or may not include additional members, and can be regarded as providing both the feature or solution of “A consists of a1, a2, and a3” and the feature or solution of “A includes not only a1, a2, and a3, but also other members”. In the present application, unless otherwise specified, A (for example, B) indicates that B is a non-limiting example of A, and it can be understood that A is not limited to B.

In the present application, the terms “optionally”, “optional”, and “option” mean that something may be not essential, that is, any one of the two parallel options of “with” and “without”. If multiple instances of “optional” appear in a single technical solution, unless otherwise specified, and there are no conflicts or mutually restrictive relationships, each instance of “optional” is independent of the other.

The following describes a secondary battery and an electric apparatus in the present application with appropriate reference to the accompanying drawings.

Generally, a secondary battery includes a positive electrode plate, a negative electrode plate, and an electrolyte. The electrolyte is disposed between the positive electrode plate and the negative electrode plate. During charging and discharging of the battery, active ions are intercalated and deintercalated back and forth between the positive electrode plate and the negative electrode plate. The electrolyte conducts ions between the positive electrode plate and the negative electrode plate. Generally, the electrolyte is liquid, that is, a liquid electrolyte.

In addition, generally, the secondary battery further includes a separator. The separator is disposed between the positive electrode plate and the negative electrode plate, mainly to prevent short circuit between positive and negative electrodes and allow ions to pass through.

An embodiment of the present application provides a secondary battery, including a positive electrode plate, a negative electrode plate, and an electrolyte disposed between the positive electrode plate and the negative electrode plate. The electrolyte includes LiFSI with a mass percentage of a. The positive electrode plate contains a positive electrode active material, Dᵥ99 of the positive electrode active material is y₁ μm, y₁ ranging from 5 to 15, and the secondary battery satisfies the following condition: 100≤y₁/a≤1000.

Without wishing to be bound by any theory, in the above secondary battery of the present application, the addition of LiFSI to the electrolyte can reduce the temperature rise. However, excessive LiFSI, due to its own poor oxidation resistance, may adversely affect the service life of the battery. The use of a positive electrode active material with a relatively small Dᵥ99 value can reduce the temperature rise. However, an excessively small Dᵥ99 may reduce the service life of the battery The present application achieves improved temperature rise performance during the fast charging process by controlling the relationship between Dᵥ99 and the LiFSI content, while mitigating the service life problems associated with LiFSI and Dᵥ99.

y₁/a reflects the relationship between the Dᵥ99 value of the positive electrode active material and the LiFSI content. An excessively high y₁/a means that either Dᵥ99 is too large or the LiFSI content is too low, either of which affects the temperature rise of the battery. However, an excessively low y₁/a means that either y1 is too small or the LiFSI content is too high, either of which affects the cycle life of the battery. The control of the Dᵥ99 value and the LiFSI content within appropriate ranges can obtain a secondary battery with better temperature rise performance and longer cycle life.

Dᵥ99 has a meaning well-known in the art, and can be tested using a known method in the art. For example, Dᵥ99 is measured by using a laser particle size analyzer (for example, Malvern Master Size 3000). Dᵥ99 represents the particle size corresponding to the cumulative percentage of the particle volume distribution reaching 99% starting from the small particle size according to the particle size volume distribution. Dᵥ50 represents the particle size corresponding to the cumulative percentage of the particle volume distribution reaching 50% starting from the small particle size according to the particle size volume distribution.

The particle size volume distribution can be obtained by testing through the following method: Take a clean beaker, add an appropriate amount of the sample to be tested, and fully ultrasonicate to ensure complete dispersion of the sample. The testing instrument is Malvern 2000 from the United States. After the sample is poured into the sample feeding tower, it circulates with the solution to the testing optical path system. Under the irradiation of the laser beam, the particle size distribution characteristics (obscuration: 8% to 12%) of the particles can be obtained by receiving and measuring the energy distribution of the scattered light. The particle size volume distribution graph is drawn based on the test data.

### Positive Electrode Plate

The positive electrode plate includes a positive electrode current collector and a positive electrode active material layer disposed on at least one surface of the positive electrode current collector, and the positive electrode active material layer includes the above positive electrode active material.

In a non-limiting example, the positive electrode current collector includes two back-to-back surfaces in a thickness direction of the positive electrode current collector, and the positive electrode active material layer is disposed on either or both of the two back-to-back surfaces of the positive electrode current collector.

In some embodiments, the positive electrode current collector may be a metal foil current collector or a composite current collector. For example, as the metal foil, aluminum foil may be used. The composite current collector may include a polymer material substrate and a metal layer formed on at least one surface of the polymer material substrate. The composite current collector may be obtained by forming a metal material on a polymer material substrate. In the positive electrode current collector, non-limiting examples of the metal material may include one or more of aluminum, aluminum alloy, nickel, nickel alloy, titanium, titanium alloy, silver, silver and alloy. In the positive electrode current collector, non-limiting examples of the polymer material substrate may include a substrate such as one or more of polypropylene (PP), polyethylene terephthalate (PET), polybutylene terephthalate (PBT), polystyrene (PS), and polyethylene (PE).

In some embodiments, a thickness of the one-sided positive electrode active material layer ranges from 26 μm to 68 μm.

As an example, Dᵥ99 of the positive electrode active material is y₁ μm, where y₁ may be 5 μm, 6 μm, 7 μm, 8 μm, 9 μm, 10 μm, 11 μm, 12 μm, 13 μm, 14 μm, 15 μm, or a value within a range defined by any two of these values. In some embodiments, y₁ ranges from 5 to 12. In other words, Dᵥ99 of the positive electrode active material ranges from 5 μm to 12 μm. The control of Dᵥ99 of the positive electrode active material within an appropriate range can avoid an excessive temperature rise in the battery, while preventing severe side reactions, so that the secondary battery has longer cycle life and lower temperature rise. Further, y₁ ranges from 5 to 10.

The positive electrode active material having the above particle size can be obtained by purchasing from the market or can be prepared by oneself. The specific preparation method may adopt known preparation methods. The nickel-cobalt-manganese ternary material is used as an example, the specific preparation steps may be as follows:

Step 1: Prepare a hydroxide precursor NiₓCo_{y}M_{1-x-y}(OH)₂: prepare a metal salt solution with Ni salt, Co salt, and M salt, with a total metal ion concentration of 1.0 mol/L to 5.0 mol/L; and perform a co-precipitation reaction between the metal salt solution and an ammonia-alkali mixed solution in a reaction kettle to prepare and obtain a precursor NiₓCo_{y}M_{1-x-y}(OH)₂, where 0<x<1, 0<y<1, and 0<1-x-y<1.

Step 2: Prepare a ternary positive electrode material LiNiₓCo_{y}M_{1-x-y}O₂: grind and mix well the precursor obtained in step 1 with a fluxing agent and LiOH·H₂O; sinter the mixture in an oxygen atmosphere, control the temperature at 700° C. to 1000° C. and control time to be 8 h to 20 h; grind, wash, filter, and dry the sintered material; and re-sinter the material in an oxygen atmosphere after drying, where re-sintering is performed by controlling the condition at 750° C. to 1000° C. for 1 h to 10 h, so as to obtain a ternary positive electrode material LiNiₓCo_{y}M_{1-x-y}O₂.

Optionally, the above ternary positive electrode material may also be surface coated. Specifically, the ternary positive electrode material obtained in step 2 is ground and mixed with a coating raw material; and the mixture is sintered in an oxygen atmosphere, the sintering condition are controlled at 700° C. to 1000° C. for 3 h to 15 h, where the coating raw material may be one or two of LiOH—H₂O or Li₂O.

In some embodiments, Dᵥ50 of the positive electrode active material is y₂ μm, and the secondary battery satisfies the following condition: 1.2≤y₁/y₂≤7. Optionally, 2≤y₁/y₂≤6.

As an example, the value of y₁/y₂ may be 1.2, 1.5, 1.8, 2, 2.5, 2.8, 2.9, 3, 3.4, 3.5, 3.8, 4, 4.2, 4.5, 6, 6.5, 7, or a value within a range defined by any two of these values.

Optionally, y₂ ranges from 1.5 to 6, more optionally, y₂ ranges from 2 to 5, and more optionally, y₂ ranges from 3 to 5.

As an example, Dᵥ50 of the positive electrode active material may be 1.5 μm, 2 μm, 2.5 μm, 2.9 μm, 3.5 μm, 4 μm, 4.5 μm, 5 μm, 5.5 μm, 5.6 μm, 5.8 μm, 6 μm, or a value within a range defined by any two of these values. The control of Dᵥ50 of the material within an appropriate range can avoid an excessive temperature rise in the battery, while preventing severe side reactions, so that the secondary battery has longer cycle life and lower temperature rise.

The control of a ratio of Dᵥ99 to Dᵥ50 of the positive electrode active material controls Dᵥ50 of the positive electrode active material within an appropriate range, so as to define the particle size distribution of the positive electrode active material, achieving an optimal balance of excellent fast charging performance, cycle life, and hot box safety performance, while having a lower temperature rise.

When y₂ is in the range of 1.5 to 6, 2 to 5, or 3 to 5, and y₁/y₂ is in the range of 2 to 6, the battery has longer cycle life and better hot box safety performance. y₁/y₂ means the difference between the Dᵥ99 value and the Dᵥ50 value, a larger ratio indicates a larger difference between the Dᵥ99 value and the Dᵥ50 value, and a smaller ratio indicates a smaller difference between the Dᵥ99 value and the Dᵥ50 value. A smaller difference indicates a more uniform particle size distribution in the positive electrode active material, facilitating the formation of lithium ion transport paths and improving fast charging performance. However, a larger Dᵥ50 tends to increase fast charging temperature rise. A larger difference indicates a more uneven particle size distribution in the positive electrode active material. A blend of different particle sizes can increase energy density. However, a smaller Dᵥ50 is conducive to reducing temperature rise, increasing side reactions, and reducing cycle life and hot box safety performance. The control of the ratio range of Dᵥ99 and Dᵥ50 of the positive electrode active material enables the battery to have better comprehensive performance.

In some embodiments, the positive electrode active material may adopt positive electrode active materials well-known in the art for batteries. In a non-limiting example, the positive electrode active material may include one or more of the following materials: olivine-structured lithium-containing phosphate, lithium transition metal oxide, and respective modified compounds thereof. However, the present application is not limited to these materials, and may alternatively use other conventional materials that can be used as positive electrode active materials for batteries. One type of these positive electrode active materials may be used alone, or two or more types may be used in combination. Examples of the lithium transition metal oxide may include but are not limited to at least one of lithium cobalt oxide (for example, LiCoO₂), lithium nickel oxide, lithium manganese oxide, lithium nickel cobalt oxide, lithium manganese cobalt oxide, lithium nickel manganese oxide, a nickel-cobalt-manganese ternary positive electrode material (also known as lithium nickel cobalt manganese oxide), lithium nickel cobalt aluminum oxide, and modified compounds thereof.

Non-limiting examples of the olivine-structured lithium-containing phosphate may include but are not limited to one or more of lithium iron phosphate, composite materials of lithium iron phosphate and carbon, lithium manganese phosphate, composite materials of lithium manganese phosphate and carbon, lithium manganese iron phosphate, and composite materials of lithium manganese iron phosphate and carbon.

Non-limiting examples of lithium cobalt oxide may include LiCoO₂. Non-limiting examples of lithium nickel oxide may include LiNiO₂. Non-limiting examples of lithium manganese oxide may include LiMnO₂, LiMn₂O₄, and the like. Non-limiting examples of lithium nickel cobalt aluminum oxide may include LiNi_{0.85}Co_{0.15}Al_{0.05}O₂.

Non-limiting examples of the nickel-cobalt-manganese ternary positive electrode material (also known as lithium nickel cobalt manganese oxide) may include LiNi_{1/3}Co_{1/3}Mn_{1/3}O₂ (NCM333 for short), LiNi_{0.5}Co_{0.2}Mn_{0.3}O₂ (NCM523 for short), LiNi_{0.5}Co_{0.25}Mn_{0.25}O₂ (NCM211 for short), LiNi_{0.5}Co_{0.15}Mn_{0.35}O₂, LiNi_{0.6}Co_{0.2}Mn_{0.2}O₂ (NCM622 for short), LiNi_{0.8}Co_{0.1}Mn_{0.1}O₂ (NCM811 for short), LiNi_{0.85}Co_{0.05}Mn_{0.1}O₂, LiNi_{0.64}Co_{0.09}Mn_{0.27}O₂, LiNi_{0.68}Co_{0.10}Mn_{0.22}O₂, and the like. It is understood that the nickel-cobalt-manganese ternary positive electrode material may also be doped with other metal elements.

It is understood that during the charging and discharging process of the battery, lithium (Li) undergoes deintercalation/intercalation and is consumed, and the Li content in the positive electrode active material varies when the battery is discharged to different states. In the enumeration of positive electrode active materials in the present application, unless otherwise specified, the Li content is in an initial state of the material. When the positive electrode active material is applied to the positive electrode plate in a battery system, after charging and discharging cycles, the Li content in the positive electrode active material contained in the electrode plate generally changes. The Li content may be measured by molar proportion, but is not limited thereto. Regarding “the content of Li is in an initial state of the material”, the initial state of the material refers to the state before being added to a positive electrode slurry. It can be understood that new materials obtained by appropriate modification based on the listed positive electrode active materials are also within the scope of positive electrode active materials, and the aforementioned appropriate modification refers to modification methods acceptable for positive electrode active materials, non-limiting examples such as coating modification.

In the enumeration of positive electrode active materials in the present application, the oxygen (O) content is only a theoretical state value, and lattice oxygen release causes changes in the molar proportion of oxygen, leading to fluctuations in the actual O content. The O content may be measured by molar proportion, but is not limited thereto.

In some embodiments, the positive electrode active material includes a nickel-cobalt-manganese ternary positive electrode material.

Further, in a total molar mass of nickel element, cobalt element, and manganese element in the nickel-cobalt-manganese ternary positive electrode material, a molar proportion of the cobalt element is 5% to 15%, and a molar proportion of the Ni element is 50% to 90%. Optionally, the molar proportion of the cobalt element is 9% to 15%, and the molar proportion of the Ni element is 50% to 70%. As an example, the value of the molar proportion of the Ni element may be 50%, 55%, 60%, 64%, 65%, 68%, 70%, 75%, 80%, 85%, or 90%. The value of the molar proportion of the cobalt element may be 5%, 6%, 9%, 10%, 12%, or 15%. The control of the Ni content and Co content of the positive electrode active material enables the battery to have longer cycle life and hot box safety performance. A higher Ni content can achieve higher energy density. However, an excessively high Ni content deteriorates the cycle life and hot box safety performance of the battery.

The molar content of each element (such as nickel cobalt manganese elements) in the positive electrode active material can be tested using methods well-known in the art, such as ICP method (trace element analysis-inductively coupled plasma emission spectrometry), using an inductively coupled plasma emission spectrometer iCAP 7400 for testing and analysis.

Optionally, in the nickel-cobalt-manganese ternary positive electrode material, the molar proportion of the cobalt element in a surface layer is greater than the molar proportion of the cobalt element in an inner layer. In other words, the composition of the inner layer and the surface layer of the nickel-cobalt-manganese ternary positive electrode material is different, with a relatively lower molar proportion of the cobalt element in the inner layer and a relatively higher molar proportion of the cobalt element in the surface layer. The gradient setting of Co in the nickel-cobalt-manganese ternary positive electrode material can effectively stabilize the structure of the positive electrode active material and improve the kinetic performance of the positive electrode plate.

It can be understood that in some examples, the difference in the molar proportion of the cobalt element between the inner layer and the surface layer can be achieved by multiple coatings using precursors of different compositions. It can be understood that the specific implementation is not limited thereto.

In some embodiments, the positive electrode active material layer may further optionally include a binder. In a non-limiting example, the binder may include one or more of polyvinylidene fluoride (PVDF), polytetrafluoroethylene (PTFE), vinylidene fluoride-tetrafluoroethylene-propylene terpolymer, vinylidene fluoride-hexafluoropropylene-tetrafluoroethylene terpolymer, tetrafluoroethylene-hexafluoropropylene copolymer, and fluorine-containing acrylic resin.

In some embodiments, the positive electrode active material layer may further optionally include a conductive agent. In a non-limiting example, the conductive agent may include one or more of superconducting carbon, acetylene black, carbon black, Ketjen black, carbon dots, carbon nanotubes, graphene, and carbon nanofiber.

In some embodiments, in the positive electrode active material layer, a mass percentage of the positive electrode active material is 75% to 98%.

In some embodiments, in the positive electrode active material layer, a mass percentage of the conductive agent is 0.1% to 15%.

In some embodiments, in the positive electrode active material layer, a mass percentage of the binder is 0.5% to 15%.

In some embodiments, the positive electrode plate may be prepared in the following manner: the foregoing constituents used for preparing the positive electrode plate, for example, the positive electrode active material, the conductive agent, the binder, and any other constituent, are dispersed in a solvent to produce a positive electrode slurry; and the positive electrode slurry is applied onto at least one side surface of the positive electrode current collector, followed by processes such as drying and cold pressing to obtain the positive electrode plate.

The type of solvent may be selected from but not limited to any one in the foregoing implementations, for example, N-methylpyrrolidone (NMP). The positive electrode slurry coated on the surface of the positive electrode current collector may be on a single surface or two surfaces of the positive electrode current collector. The solid content of the positive electrode slurry may be 40 wt % to 80 wt %. The viscosity of the positive electrode slurry at room temperature may be adjusted to 5000 mPa-s to 25000 mPa-s. During the coating of the positive electrode slurry, coating surface density per unit in terms of dry weight (solvent excluded) may range from 15 mg/cm² to 35 mg/cm². The compaction density of the positive electrode plate may range from 3.0 g/cm³ to 3.6 g/cm³, optionally, the compaction density may range from 3.3 g/cm³ to 3.5 g/cm³.

### Negative Electrode Plate

Generally, the negative electrode plate includes a negative electrode current collector and a negative electrode film layer disposed on at least one surface of the negative electrode current collector.

In a non-limiting example, the negative electrode current collector includes two back-to-back surfaces in a thickness direction of the negative electrode current collector, and the negative electrode active material layer is disposed on either or both of the two back-to-back surfaces of the negative electrode current collector.

In some embodiments, the negative electrode current collector may be a metal foil current collector or a composite current collector. For example, as the metal foil, copper foil may be used. The composite current collector may include a polymer material substrate and a metal layer formed on at least one surface of the polymer material substrate. The composite current collector may be obtained by forming a metal material on a polymer material substrate. In the negative electrode current collector, non-limiting examples of the metal material may include one or more of copper, copper alloy, nickel, nickel alloy, titanium, titanium alloy, silver, and silver alloy. In the negative electrode current collector, non-limiting examples of the polymer material substrate may include a substrate such as one or more of polypropylene (PP), polyethylene terephthalate (PET), polybutylene terephthalate (PBT), polystyrene (PS), and polyethylene (PE).

Further, the negative electrode film layer may include a negative electrode active material layer, and the negative electrode active material layer includes a negative electrode active material.

In some embodiments, a thickness of the one-sided negative electrode active material layer ranges from 22 μm to 110 μm.

In some embodiments, the negative electrode active material may adopt negative electrode active materials well-known in the art for batteries. In a non-limiting example, the negative electrode active material may include one or more of the following materials: artificial graphite, natural graphite, soft carbon, hard carbon, silicon-based materials, tin-based materials, lithium titanate, and the like. The silicon-based material may include one or more of elemental silicon, silicon-oxygen compounds, silicon-carbon composites, silicon-nitrogen composites, and silicon alloys. The tin-based material may include one or more of elemental tin, tin oxide compounds, and tin alloys. However, the present application is not limited to these materials, and may alternatively use other conventional materials that can be used as negative electrode active materials for batteries. One of these negative electrode active materials may be used alone, or more than two of them may be used in combination.

In some embodiments, the negative electrode active material layer may further optionally include a binder. The binder may include one or more of styrene-butadiene rubber (SBR), polyacrylic acid (PAA), polyacrylic acid sodium (PAAS), polyacrylamide (PAM), polyvinyl alcohol (PVA), sodium alginate (SA), polymethacrylic acid (PMAA), and carboxymethyl chitosan (CMCS).

In some embodiments, the negative electrode active material layer may further optionally include a conductive agent. The conductive agent may include one or more of superconducting carbon, acetylene black, carbon black, Ketjen black, carbon dots, carbon nanotubes, graphene, and carbon nanofiber.

In some embodiments, the negative electrode active material layer may further optionally include other additives such as a thickener (for example, sodium carboxymethyl cellulose (CMC-Na)).

In some embodiments, in the negative electrode film layer, a mass percentage of the negative electrode active material is 75% to 98%.

In some embodiments, in the negative electrode film layer, a mass percentage of the conductive agent is 0.1% to 15%.

In some embodiments, in the negative electrode film layer, a mass percentage of the binder is 0.5% to 15%.

In some embodiments, the compaction density of the negative electrode plate is less than 1.6 g/cm³; and optionally, the compaction density may range from 1.3 g/cm³ to 1.5 g/cm³. The control of the setting of the smaller compaction density of the negative electrode plate allows for larger pores within the negative electrode plate, thereby improving the wetting of the electrolyte and facilitating the Li⁺ transport, thereby improving the overall kinetic performance of the secondary battery, which is conducive to improving fast charging performance. It can be understood that the compaction density of the negative electrode plate refers to the compaction density of the negative electrode film layer on the negative electrode plate. The steps of compaction density test are as follows: Disassemble a cell to obtain the electrode plate, and punch the electrode plate into small discs with an area S; measure the weight M and thickness L of the small disc; take another layer of electrode plate, wipe off the surface film layer to leave the bare current collector foil, similarly punch the electrode plate into small discs with an area S, weigh the mass M0 of the bare aluminum foil, then compaction density PD=(M−M0)/(S*n*L), where n is the quantity of film layers coated on the current collector, which is 1 or 2, one-sided coating or double-sided coating. In a specific example, S is 1540.25 mm².

In some embodiments, the negative electrode plate may be prepared in the following manner: the foregoing constituents used for preparing the negative electrode plate, for example, the negative electrode active material, the conductive agent, the binder, and any other constituent, are dispersed in a solvent (for example, deionized water) to produce a negative electrode slurry; and the negative electrode slurry is applied onto at least one side surface of the negative electrode current collector, followed by processes such as drying and cold pressing to obtain the negative electrode plate.

The negative electrode slurry coated on the surface of the negative electrode current collector may be on a single surface or two surfaces of the negative electrode current collector. The solid content of the negative electrode slurry may be 40 wt % to 60 wt %. The viscosity of the negative electrode slurry at room temperature may be adjusted to 2000 mPa-s to 10000 mPa-s.

### Electrolyte

The electrolyte conducts ions between the positive electrode plate and the negative electrode plate. The electrolyte of the present application adopts a liquid electrolyte. The liquid electrolyte includes an electrolytic salt and a solvent. As described above, the liquid electrolyte includes LiFSI with a mass percentage of a.

In some embodiments, 0<a≤10%. As an example, the value of a may be 0.01%, 0.02%, 0.05%, 0.1%, 0.5%, 1%, 2%, 3%, 4%, 5%, 6%, 7%, 8%, 9%, 10%, or a value within a range defined by any two of these values. Optionally, 0.01%≤a≤10%, optionally, 0.1%≤a≤5%; further, 1%≤a≤5%, and more optionally, 1%≤a≤5%.

Further, 2%≤a≤4%, and more optionally, 2%≤a≤4%.

As an example, the value of y₁/a may be 100, 120, 150, 160, 167, 170, 200, 233, 300, 330, 333, 340, 400, 500, 600, 1000, 2000, 3000, 4000, 5000, 6000, 7000, 8000, 9000, 10000. The value of y₁/a may be in a range defined by any two of these values. Further, 200≤y₁/a≤5000, or 100≤y₁/a≤5000; 200≤y₁/a≤600; or a value within a range defined by any two of these values.

In some embodiments, the electrolyte includes LiFSI with a mass percentage of a, where 0.1%≤a≤5%; the positive electrode plate contains a positive electrode active material, and Dᵥ99 of the positive electrode active material is y₁ μm, y₁ ranging from 5 to 10. This enables the secondary battery to satisfy the following condition: 100≤y₁/a≤1000.

In some embodiments, the electrolytic salt may further include one or more of lithium hexafluorophosphate (LiPF₆), lithium tetrafluoroborate (LiBF₄), lithium perchlorate (LiClO₄), lithium hexafluoroarsenate (LiAsF₆), lithium bis(trifluoromethane)sulfonimide (LiTFSI), lithium trifluoromethanesulfonate (LiTFS), lithium difluorophosphate (LiPO₂F₂), lithium difluoro(oxalato)borate (LiDFOB), lithium bis(oxalato)borate (LiBOB), lithium difluoro bis(oxalato)phosphate (LiDFOP), and lithium tetrafluoro oxalato phosphate (LiTFOP).

In some embodiments, the solvent may include one or more of ethylene carbonate (EC), propylene carbonate (PC), ethyl methyl carbonate (EMC), diethyl carbonate (DEC), dimethyl carbonate (DMC), dipropyl carbonate (DPC), methyl propyl carbonate (MPC), ethyl propyl carbonate (EPC), fluoroethylene carbonate (FEC), methyl formate, methyl acetate, ethyl acetate, propyl acetate, methyl propionate, ethyl propionate, propyl propionate, methyl butyrate, ethyl butyrate, 1,4-butyrolactone, sulfolane, methyl sulfonyl methane, ethyl methanesulfonate, and diethyl sulfone.

In some embodiments, the electrolyte may further optionally include an additive. For example, the additive may include a negative electrode film-forming additive or a positive electrode film-forming additive, or may include an additive capable of improving some performance of the battery, for example, an additive for improving overcharge performance of the battery, or an additive for improving high-temperature or low-temperature performance of the battery.

In some implementations, the additive in the electrolyte may include, but is not limited to, one or more of difluoroethylene carbonate (DFEC) and trifluoropropylene carbonate (TFPC).

### Separator

The separator is disposed between the positive electrode plate and the negative electrode plate, mainly to prevent short circuit between positive and negative electrodes and allow ions to pass through.

In some embodiments, a Gurley value of the separator is 100s to 600s.

Optionally, the Gurley value of the separator is 150s to 600s; and more optionally, the Gurley value of the separator is 400s to 600s, or 400s to 500s.

The separator with its Gurley value controlled within the above smaller range results in lower impedance and better kinetic performance. When used in combination with an electrolyte containing LiFSI, better fast charging capability can be achieved.

The Gurley value of the separator may be obtained by testing in the following manner: Place the separator in an air permeability tester, and the time required for 100 mL of air to pass through 1 square inch of the separator under a pressure of 1.22 kPa, in units of seconds (s).

In some embodiments, the material of the separator may include one or more of glass fiber, non-woven fabric, polyethylene, polypropylene, and polyvinylidene fluoride. The separator may be a single-layer film or a multi-layer composite film, which is not particularly limited. When the separator is a multi-layer composite film, all layers may be made of the same or different materials, which is not particularly limited.

In some implementations, a thickness of the separator is 6 μm to 40 μm, and optionally 12 μm to 20 μm.

In some embodiments, the positive electrode plate, negative electrode plate, and separator may be made into an electrode assembly through winding or stacking.

In some embodiments, the secondary battery may include an outer package. The outer package may be used for packaging the electrode assembly and the electrolyte.

In some embodiments, the outer package of the secondary battery may be a hard shell, for example, a hard plastic shell, an aluminum shell, or a steel shell. The outer package of the secondary battery may alternatively be a soft pack, for example, a soft pouch. The material of the soft package may be plastic, and further, non-limiting examples of the plastic may include one or more of polypropylene, polybutylene terephthalate, and polybutylene succinate.

The secondary battery includes at least one battery cell. The secondary battery may include one or more battery cells. In one example, the secondary battery may also be a battery cell.

In the present application, unless otherwise specified, “battery cell” refers to a basic unit that can achieve mutual conversion between chemical energy and electrical energy, and further, generally includes at least a positive electrode plate, a negative electrode plate, and an electrolyte. During the charging and discharging process of the battery, active ions are intercalated and deintercalated back and forth between the positive electrode plate and the negative electrode plate. The electrolyte conducts active ions between the positive electrode plate and the negative electrode plate.

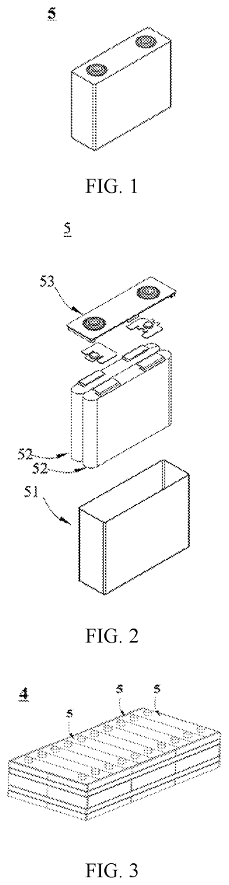

The battery cell is not limited to a particular shape in the present application, and may be cylindrical, rectangular, or of any other shapes. For example, FIG. 1 shows a rectangular battery cell 5 as an example.

In some embodiments, referring to FIG. 2, the outer package may include a housing 51 and a cover plate 53. The housing 51 may include a base plate and side plates connected to the base plate, and the base plate and the side plates enclose an accommodating cavity. The housing 51 has an opening communicating with the accommodating cavity, and the cover plate 53 can cover the opening to close the accommodating cavity. The positive electrode plate, negative electrode plate, and separator may be made into an electrode assembly 52 through winding or stacking. The electrode assembly 52 is packaged in the accommodating cavity. The electrolyte is infiltrated in the electrode assembly 52. There may be one or more electrode assemblies 52 in the battery cell 5, and persons skilled in the art may make choices depending on actual needs.

The secondary battery may be a battery module 4 or a battery pack 1.

The battery module includes at least one battery cell. One or more battery cells may be contained in the battery module, and persons skilled in the art may select an appropriate number according to use and capacity of the battery module.

FIG. 3 shows a battery module 4 as an example. Referring to FIG. 3, in the battery module 4, multiple battery cells 5 may be arranged sequentially along the length direction of the battery module 4. Certainly, the battery cells may alternatively be arranged in any other manners. Further, the multiple battery cells 5 may be fastened through fasteners.

Optionally, the battery module 4 may further include a shell with an accommodating space, and the multiple battery cells 5 are accommodated in the accommodating space.

In some embodiments, the battery module may be further assembled into a battery pack, and the battery pack may include one or more battery modules. Persons skilled in the art may select an appropriate number according to use and capacity of the battery pack.

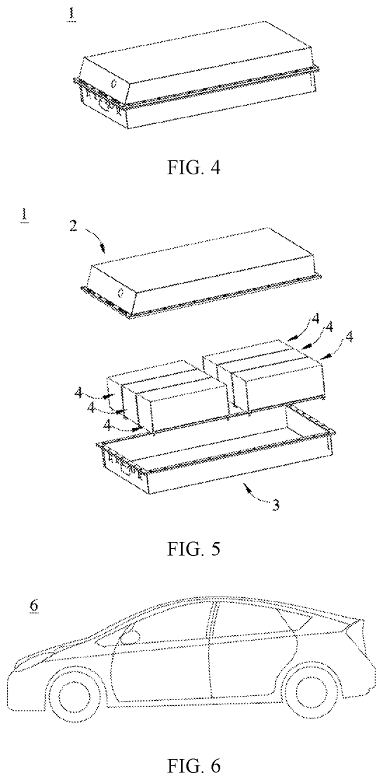

FIG. 4 and FIG. 5 show a battery pack 1 as an example. Referring to FIG. 4 and FIG. 5, the battery pack 1 may include a battery box and multiple battery modules 4 provided in the battery box. The battery box includes an upper box body 2 and a lower box body 3, and the upper box body 2 and the lower box body 3 can fit to form an enclosed space for accommodating the battery modules 4. The multiple battery modules 4 may be arranged in the battery box in any manner.

In addition, the present application also provides an electric apparatus, the electric apparatus includes the secondary battery provided by the present application. The secondary battery may be used as a power source for the electric apparatus or an energy storage unit for the electric apparatus. The electric apparatus may include a mobile device, an electric vehicle, an electric train, a ship, a satellite system, an energy storage system, or the like, but is not limited thereto. The mobile device may be, for example, a mobile phone or a notebook computer; and the electric vehicle may be, for example, a battery electric vehicle, a hybrid electric vehicle, a plug-in hybrid electric vehicle, an electric bicycle, an electric scooter, an electric golf vehicle, or an electric truck, but is not limited thereto.

The secondary battery may be selected for the electric apparatus based on requirements for using the electric apparatus.

FIG. 6 shows an electric apparatus 6 as an example. The electric apparatus is a battery electric vehicle, a hybrid electric vehicle, a plug-in hybrid electric vehicle, or the like. To satisfy requirements of the electric apparatus for high power and high energy density of the secondary battery, a battery pack or a battery module may be used.

In another example, the electric apparatus may be a mobile phone, a tablet computer, a notebook computer, or the like. Such apparatus is generally required to be light and thin and may use a secondary battery as its power source.

The following are specific examples.

The following describes the examples of the present application. The examples described below are illustrative and merely used for explaining the present application, and cannot be construed as limitations on the present application. Examples whose technical solutions or conditions are not specified are made in accordance with technical solutions or conditions described in literature in the field or made in accordance with product instructions. The reagents or instruments used are all conventional products that are commercially available if no manufacturer is indicated.

### Example 1

### (1) Preparation of Positive Electrode Plate

A positive electrode active material LiNi_{0.68}Co_{0.10}Mn_{0.22}O₂, a conductive agent carbon black (Super P), and a binder polyvinylidene fluoride (PVDF) were mixed to uniformity at a mass ratio of 96.2:2.7:1.1 in an appropriate amount of solvent N-methylpyrrolidone (NMP) to obtain a positive electrode slurry. The positive electrode slurry was applied on a positive electrode current collector aluminum foil, followed by processes such as drying, cold pressing, slitting, and cutting to form a positive electrode active material layer with a thickness of 38 μm, to obtain a positive electrode plate. Dᵥ99 of the positive electrode active material was y₁ μm, and Dᵥ50 was y₂ μm. For details, refer to Table 1.

### (2) Preparation of Negative Electrode Plate

A negative electrode active material artificial graphite, a conductive agent carbon black (Super P), a binder styrene-butadiene rubber (SBR), and sodium carboxymethyl cellulose (CMC-Na) were mixed to uniformity at a mass ratio of 96.4:0.7:1.8:1.1 in an appropriate amount of solvent deionized water to obtain a negative electrode slurry. The negative electrode slurry was applied on a negative electrode current collector copper foil, followed by processes of drying, cold pressing, slitting, and cutting to form a negative electrode active material layer with a single-sided thickness of 54 μm, to obtain a negative electrode plate. The compaction density of the negative electrode plate was 1.45 g/cm³.

### (3) Separator

A polypropylene separator with a thickness of 12 μm was used. For a Gurley value of the separator, refer to table 1.

### (4) Preparation of Electrolyte

Ethylene carbonate (EC) and ethyl methyl carbonate (EMC) were mixed at a mass ratio of 30:70 to obtain an organic solvent. Then, LiFSI, accounted for 3 wt % of the entire electrolyte, was dissolved in the mixed solvent, and fully dried LiPF₆ was dissolved in the above organic solvent to prepare an electrolyte with a LiPF₆ concentration of 1 mol/L.

### (5) Preparation of Secondary Battery

The positive electrode plate, the separator, and the negative electrode plate were sequentially stacked and wound to obtain an electrode assembly. The electrode assembly was placed into an outer package and dried. Then the electrolyte was injected, and processes such as vacuum packaging, standing, formation, and shaping were performed to obtain a secondary battery. The ratio of the mass of the electrolyte to the capacity of the secondary battery was 2.2 g/Ah. For details, refer to table 1.

### Examples 2 to 6

The preparation methods for the secondary batteries in Examples 2 to 6 were similar to those for the secondary battery in Example 1, except that the mass percentage a of LiFSI in the electrolyte was different. For details, refer to table 1.

### Examples 7 to 15

The preparation methods for the secondary batteries in Examples 7 to 15 were similar to those for the secondary battery in Example 1, except that Dᵥ99 (that is, y₁) of the positive electrode active material LiNi_{0.68}Co_{0.10}Mn_{0.22}O₂ and/or Dᵥ50 of the positive electrode active material LiNi_{0.68}Co_{0.10}Mn_{0.22}O₂ was different. For details, refer to Table 1.

### Examples 16 to 19

The preparation methods for the secondary batteries in Examples 16 to 19 were similar to those for the secondary battery in Example 1, except that the molar proportion of the nickel element and the molar proportion of the cobalt element in the NCM ternary material of the positive electrode active material were different.

### Examples 20 to 22

The preparation methods for the secondary batteries in Examples 20 to 22 were similar to those for the secondary battery in Example 1, except that the Gurley value of the separator was different. For details, refer to Table 1.

### Comparative Examples 1 and 2

The preparation methods for the secondary batteries in Comparative Examples 1 and 2 were similar to those for the secondary battery in Example 1, except that the mass percentage a of LiFSI in the electrolyte and Dᵥ99 (that is, y₁) of the positive electrode active material LiNi_{0.68}Co_{0.10}Mn_{0.22}O₂ were different and the value of y1/a was different. For details, refer to Table 1.

TABLE 1

| | | Positive electrode plate-positive | | | | | | |
|---|---|---|---|---|---|---|---|---|
| | | electrode active material | | | | | | |
| | Electrolyte | | Molar | | | | | |
| | Mass | Composition of | proportion | | | | | Separator |
| | percentage | positive electrode | of nickel | y₁ | | y₂ | | Gurley |
| Group | a of LiFSI | active material | element | (μm) | y₁/a | (μm) | y₁/y₂ | value (s) |
| Example 1 | 3.0% | LiNi_{0.68}Co_{0.10}Mn_{0.22}O₂ | 68% | 10 | 333 | 3.50 | 2.86 | 500 |
| Example 2 | 0.1% | LiNi_{0.68}Co_{0.10}Mn_{0.22}O₂ | 68% | 10 | 10000 | 3.50 | 2.86 | 500 |
| Example 3 | 0.2% | LiNi_{0.68}Co_{0.10}Mn_{0.22}O₂ | 68% | 10 | 5000 | 3.50 | 2.86 | 500 |
| Example 4 | 1.0% | LiNi_{0.68}Co_{0.10}Mn_{0.22}O₂ | 68% | 10 | 1000 | 3.50 | 2.86 | 500 |
| Example 5 | 5.0% | LiNi_{0.68}Co_{0.10}Mn_{0.22}O₂ | 68% | 10 | 200 | 3.50 | 2.86 | 500 |
| Example 6 | 10.0% | LiNi_{0.68}Co_{0.10}Mn_{0.22}O₂ | 68% | 10 | 100 | 3.50 | 2.86 | 500 |
| Example 7 | 3.0% | LiNi_{0.68}Co_{0.10}Mn_{0.22}O₂ | 68% | 5 | 167 | 3.50 | 1.43 | 500 |
| Example 8 | 3.0% | LiNi_{0.68}Co_{0.10}Mn_{0.22}O₂ | 68% | 12 | 400 | 3.50 | 3.43 | 500 |
| Example 9 | 3.0% | LiNi_{0.68}Co_{0.10}Mn_{0.22}O₂ | 68% | 15 | 500 | 3.50 | 4.29 | 500 |
| Example 10 | 3.0% | LiNi_{0.68}Co_{0.10}Mn_{0.22}O₂ | 68% | 7 | 233 | 5.80 | 1.21 | 500 |
| Example 11 | 3.0% | LiNi_{0.68}Co_{0.10}Mn_{0.22}O₂ | 68% | 7 | 233 | 5.60 | 1.25 | 500 |
| Example 12 | 3.0% | LiNi_{0.68}Co_{0.10}Mn_{0.22}O₂ | 68% | 10 | 333 | 2.50 | 4.00 | 500 |
| Example 13 | 3.0% | LiNi_{0.68}Co_{0.10}Mn_{0.22}O₂ | 68% | 10 | 333 | 4.00 | 2.50 | 500 |
| Example 14 | 3.0% | LiNi_{0.68}Co_{0.10}Mn_{0.22}O₂ | 68% | 10 | 333 | 1.50 | 6.67 | 500 |
| Example 15 | 3.0% | LiNi_{0.68}Co_{0.10}Mn_{0.22}O₂ | 68% | 10 | 333 | 6.00 | 1.67 | 500 |
| Example 16 | 3.0% | LiNi_{0.64}Co_{0.09}Mn_{0.27}O₂ | 64% | 10 | 333 | 3.50 | 2.86 | 500 |
| Example 17 | 3.0% | LiNi_{0.5}Co_{0.15}Mn_{0.35}O₂ | 50% | 10 | 333 | 3.50 | 2.86 | 500 |
| Example 18 | 3.0% | LiNi_{0.8}Co_{0.10}Mn_{0.1}O₂ | 80% | 10 | 333 | 3.50 | 2.86 | 500 |
| Example 19 | 3.0% | LiNi_{0.85}Co_{0.05}Mn_{0.1}O₂ | 85% | 10 | 333 | 3.50 | 2.86 | 500 |
| Example 20 | 3.0% | LiNi_{0.68}Co_{0.10}Mn_{0.22}O₂ | 68% | 10 | 333 | 3.50 | 2.86 | 400 |
| Example 21 | 3.0% | LiNi_{0.68}Co_{0.10}Mn_{0.22}O₂ | 68% | 10 | 333 | 3.50 | 2.86 | 600 |
| Example 22 | 3.0% | LiNi_{0.68}Co_{0.10}Mn_{0.22}O₂ | 68% | 10 | 333 | 3.50 | 2.86 | 100 |
| Comparative | 0.1% | LiNi_{0.68}Co_{0.10}Mn_{0.22}O₂ | 68% | 25 | 25000 | 3.50 | 7.14 | 500 |
| Example 1 | | | | | | | | |
| Comparative | 12.0% | LiNi_{0.68}Co_{0.10}Mn_{0.22}O₂ | 68% | 5 | 42 | 3.50 | 1.43 | 500 |
| Example 2 | | | | | | | | |

The above description of each example tends to emphasize the differences between the various examples, and their identical or similar aspects can be referred to each other. For brevity, details are not repeated herein.

The following are performance tests.

(1) Fast charging capability test: The batteries of the above examples and comparative examples were first charged and discharged at a current of 1C (that is, a current at which the theoretical capacity of the battery was fully discharged in 1 h). The specific steps were as follows: At 35° C., the batteries were charged to a voltage of 4.4 V at a constant current of 1C, then charged to a current less than or equal to 0.05C at a constant voltage, left standing for 5 min, then discharged to a voltage of 2.8 V at a constant current of 0.33C, and the actual capacity thereof was recorded as CO. Then, each battery was sequentially charged to a full-battery charging cut-off voltage of 4.4 V or a negative electrode cut-off potential of 0 V (whichever was reached first) at constant current of 1.0C0, 1.3C0, 1.5C0, 1.8C0, 2.0C0, 2.3C0, 2.5C0, 3.0C0, 3.5C0, 4C0, 4.5C0, and 5C0. After each charging was completed, the battery was discharged to a full-battery discharging cut-off voltage of 2.8 V at 1C0, and the negative electrode potentials corresponding to charging to 10%, 20%, 30%, . . . , 80% SOC (State of Charge, state of charge, when “SOCK”, it indicates that the battery is fully discharged; and when “SOC=100%”, it indicates that the battery is fully charged) under different charging rates were recorded. The charging rate-negative electrode potential curves under different SOC states were drawn, and linear fitting was performed to obtain the charging rate corresponding to the negative electrode potential of 0 V under different SOC states. These charging rates were charging windows under different SOC states, recorded as C(10% SOC), C(20% SOC), C(30% SOC), C(40% SOC), C(50% SOC), C(60% SOC), C(70% SOC), and C(80% SOC). A charging time T for the battery from 10% SOC to 80% SOC was calculated according to the formula (60/C(20% SOC)+60/C(30% SOC)+60/C(40% SOC)+60/C(50% SOC)+60/C(60% SOC)+60/C(70% SOC)+60/C(80% SOC))×10%, in units of min. A shorter time indicated better fast charging performance of the battery.

(2) Fast charging cycle life: Stepwise charging was performed using the charging rates under each SOC obtained from the fast charging capability test, the battery was charged to 10% SOC at a constant current rate of C(10% SOC), then charged to 20% SOC at a constant current rate of C(20% SOC), charged to 30% SOC at a constant current rate of C(30% SOC), charged to 40% SOC at a constant current rate of C(40% SOC), charged to 50% SOC at a constant current rate of C(50% SOC), charged to 60% SOC at a constant current rate of C(60% SOC), charged to 70% SOC at a constant current rate of C(70% SOC), charged to 80% SOC at a constant current rate of C(80% SOC), charged to 100% SOC at a constant current rate of 0.33C, and then discharged to 2.5 V at a discharge rate of 0.33C. The battery was cycled according to the above process, and the number of cycles when its capacity faded to 80% SOH was recorded.

The number of cycles when the capacity faded to 80% SOH was calculated by the following method: From small to large, the discharge capacity of the nth cycle was divided by the discharge capacity of the first cycle, and the ratio was recorded, respectively. When this ratio was first found to be equal to or less than 80% SOH, this number of cycles was the number of cycles when the capacity faded to 80% SOH, which was the fast charging cycle life parameter in Table 2.

A larger number of cycles indicated better fast charging cycle life of the battery.

(3) Fast charging temperature rise test: A single charging-discharging cycle was performed using the same process as in the fast charging cycle life test, and a temperature sensing wire was used to measure and record the temperature rise (that is, the temperature difference before and after charging and discharging) of the large surface of the cell during this process.

(4) Hot box safety test: A cell was first fully charged to the corresponding design upper limit voltage, the cell was clamped with a fixture, the temperature inside the hot box was raised from room temperature at 2° C./min to 100° C., the cell was maintained at that temperature for 1 hour, then raised at 5° C./min, and maintained for 30 min every 5° C., until the cell failed (vented, smoke, or caught fire), the test was stopped. The upper limit temperature was set to 250° C. The temperature inside the hot box was recorded when the cell failed. The temperature inside this hot box represented the hot box safety performance. For specific values, refer to the hot box safety performance (° C.) in Table 2.

The test results are shown in Table 2.

TABLE 2

| | Performance test | | | |
|---|---|---|---|---|
| | Fast charging | | | Hot box |
| | time T (min) | Fast charging | Fast charging | safety |
| | from 10% SOC | cycle life | temperature | performance |
| Group | to 80% SOC | (cycles) | rise (° C.) | (° C.) |
| Example 1 | 11.50 | 2435 | 45.0 | 165.0 |
| Example 2 | 12.30 | 2256 | 48.0 | 161.0 |
| Example 3 | 12.20 | 2294 | 47.5 | 161.5 |
| Example 4 | 12.00 | 2335 | 47.0 | 162.0 |
| Example 5 | 11.20 | 2131 | 44.0 | 164.0 |
| Example 6 | 10.50 | 1889 | 46.0 | 160.0 |
| Example 7 | 11.40 | 2010 | 43.0 | 160.0 |
| Example 8 | 11.60 | 2478 | 46.0 | 166.0 |
| Example 9 | 11.70 | 2534 | 48.0 | 167.0 |
| Example 10 | 11.80 | 2198 | 49.0 | 169.0 |
| Example 11 | 11.70 | 2230 | 48.8 | 169.5 |
| Example 12 | 11.30 | 2304 | 44.0 | 163.0 |
| Example 13 | 11.60 | 2450 | 46.0 | 167.0 |
| Example 14 | 11.10 | 2140 | 43.0 | 161.0 |
| Example 15 | 12.00 | 2196 | 46.0 | 165.0 |
| Example 16 | 11.50 | 2335 | 45.0 | 165.0 |
| Example 17 | 11.60 | 2330 | 46.0 | 168.0 |
| Example 18 | 11.40 | 2240 | 44.0 | 161.0 |
| Example 19 | 11.50 | 2140 | 45.0 | 159.0 |
| Example 20 | 11.20 | 2476 | 44.0 | 163.0 |
| Example 21 | 12.10 | 2378 | 46.0 | 166.0 |
| Example 22 | 10.30 | 2231 | 42.0 | 158.0 |
| Comparative | 14.30 | 1887 | 55.0 | 167.0 |
| Example 1 | | | | |
| Comparative | 10.10 | 1389 | 46.0 | 143.0 |
| Example 2 | | | | |

The fast charging time in Table 2 can characterize the fast charging performance of the secondary battery. A shorter fast charging time indicates better fast charging performance of the battery. The fast charging cycle life (number of cycles at 80% SOH) can characterize the cycle life of the battery. A larger fast charging cycle life (number of cycles at 80% SOH) indicates its longer fast charging cycle life.

The fast charging temperature rise and hot box safety test in Table 2 can characterize the thermal runaway situation resulting from an excessive temperature rise during the fast charging process. A smaller fast charging temperature rise indicates a lower risk of thermal runaway resulting from an excessive temperature rise during the fast charging process, and thus leading to a better temperature rise performance. A higher furnace temperature when the cell fails in the hot box safety test indicates a lower risk of thermal runaway resulting from an excessive temperature rise during the fast charging process, and thus leading to a better hot box safety performance.

With reference to Tables 1 and 2, it can be seen that the preparation methods for the secondary batteries in Comparative Examples 1 and 2 are similar to those for the secondary battery in Example 1, except that at least one of the mass percentage a of LiFSI in the electrolyte and Dᵥ99 (that is, y₁) of the positive electrode active material is different. In Comparative Example 1, Dᵥ99 of the positive electrode active material is larger, and y1/a is larger, resulting in a larger fast charging time T of the secondary battery, shorter cycle life, and larger temperature rise, indicating poor fast charging performance, poor cycle life, and large temperature rise of the battery. In Comparative Example 2, the mass percentage a is larger, y₁/a is smaller, the cycle life of the secondary battery is reduced, the furnace temperature when the cell fails is lower, and the hot box safety performance is poor.

Compared with the comparative examples, each example can balance the secondary battery having better fast charging cycle life.

From Examples 1 to 10, it can be seen that the control of y₁/a within 200≤y₁/a≤5000 can further improve the fast charging performance and cycle life of the battery, while having lower temperature rise and better hot box safety performance. The control of y₁/a within 200≤y₁/a≤600 can further improve the comprehensive performance of the secondary battery.

The secondary batteries in Examples 7 to 9 differ from that in Example 1 in that Dᵥ99 (that is, y₁) of the positive electrode active material is different, and all have good comprehensive performance. Further, the control of Dᵥ99 of the positive electrode active material to range from 5 μm to 12 μm enables the secondary battery to have better fast charging performance and lower temperature rise.

The secondary batteries in Examples 12 to 15 differ from that in Example 1 in that Dᵥ50 (that is, y₂) of the positive electrode active material is different, and y₁/y₂ is accordingly different, and all had good comprehensive performance. Further, when y₂ ranges from 2 to 5 and y₁/y₂ is in the range of 2 to 6, the secondary battery has better fast charging performance and cycle life, while having lower temperature rise and better safety performance.

The secondary batteries in Examples 16 to 19 differ from that in Example 1 in that the nickel content and cobalt content of the positive electrode active material are different. Further, when the molar proportion of the cobalt element is 9% to 15% and the molar proportion of the nickel element is 50% to 70%, the secondary battery has longer cycle life and better hot box safety performance.

The secondary batteries in Examples 20 to 22 differ from that in Example 1 in that the Gurley value of the separator is different, and all had good fast charging performance and the effect of reducing the risk of thermal runaway resulting from an excessive temperature rise during the fast charging process. Further, when the Gurley value of the separator is in the range of 400s to 600s, the secondary battery has longer cycle life and better hot box safety performance.

It should be noted that the present application is not limited to the foregoing implementations. The foregoing implementations are merely examples, and implementations having substantially the same constructions and having the same effects as the technical idea within the scope of the technical solutions of the present application are all included in the technical scope of the present application. In addition, without departing from the essence of the present application, various modifications made to the implementations that can be conceived by persons skilled in the art, and other forms constructed by combining some of the constituent elements in the implementations are also included in the scope of the present application.

1. A secondary battery, comprising a positive electrode plate, a negative electrode plate, and an electrolyte disposed between the positive electrode plate and the negative electrode plate, wherein the electrolyte comprises LiFSI with a mass percentage of a, the positive electrode plate contains a positive electrode active material, Dᵥ99 of the positive electrode active material is y₁ μm, y₁ ranging from 5 to 15, and the secondary battery satisfies the following condition: 100≤y₁/a≤10000.

2. The secondary battery according to claim 1, wherein the secondary battery satisfies at least one of the following conditions:
y₁ ranges from 5 to 12; (1)
0<a≤10%; and (2)
200≤y₁/a≤5000. (3)

3. The secondary battery according to claim 1, wherein y₁ ranges from 5 to 10.

4. The secondary battery according to claim 1, wherein 0.01%≤a≤10%.

5. The secondary battery according to claim 1, wherein 0.1%≤a≤5%.

6. The secondary battery according to claim 1, wherein the secondary battery satisfies at least one of the following conditions:
$$1 \% \leq a \leq 5 \% ; and \qquad ( 1 )$$
$$200 \leq {y}_{1} / a \leq 600 . \qquad ( 2 )$$

7. The secondary battery according to claim 6, wherein 2%≤a≤4%.

8. The secondary battery according to claim 1, wherein Dᵥ50 of the positive electrode active material is y₂ μm, and the secondary battery satisfies the following condition: 1.25≤y₁/y₂≤7.

9. The secondary battery according to claim 8, wherein the secondary battery satisfies at least one of the following conditions:
y₂ ranges from 1.5 to 6; and (1)
2≤y₁/y₂≤6. (2)

10. The secondary battery according to claim 9, wherein y₂ ranges from 2 to 5.

11. The secondary battery according to claim 1, wherein the positive electrode active material comprises a nickel-cobalt-manganese ternary positive electrode material.

12. The secondary battery according to claim 11, wherein in a total molar mass of nickel element, cobalt element, and manganese element in the nickel-cobalt-manganese ternary positive electrode material, a molar proportion of the cobalt element is 5% to 15%, and a molar proportion of the nickel element is 50% to 90%.

13. The secondary battery according to claim 12, wherein in the total molar mass of nickel element, cobalt element, and manganese element in the nickel-cobalt-manganese ternary positive electrode material, the molar proportion of the cobalt element is 9% to 15%, and the molar proportion of the nickel element is 50% to 70%.

14. The secondary battery according to claim 1, wherein the secondary battery further comprises a separator disposed between the positive electrode plate and the negative electrode plate, and a Gurley value of the separator is 100s to 600s.

15. The secondary battery according to claim 14, wherein the Gurley value of the separator is 400s to 500s.

16. An electric apparatus, comprising the secondary battery according to claim 1.
